(19) United States
(12) Patent Application Publication
(10) Pub. No.: US 2026/0233778 A1
(43) Pub. Date: Aug. 13, 2026

(54) PARKING ASSISTANCE DEVICE

(71) Applicant: AISIN CORPORATION, Kariya, Aichi (JP)

(72) Inventor: Daisuke SATO, Kariya-shi, Aichi-ken (JP)

(73) Assignee: AISIN CORPORATION, Kariya, Aichi (JP)

(21) Appl. No.: 19/154,184

(22) PCT Filed: Mar. 20, 2024
(86) PCT No.: PCT/JP2024/010876

§ 371 Date: Aug. 6, 2025

(30) Foreign Application Priority Data
Apr. 27, 2023 (JP) 2023-073198

(51) Int. Cl. B62D 13/06; B60W 10/10; B60W 10/18; B60W 10/20; B60W 30/06; B60W 50/14; B62D 15/02

(52) U.S. Cl. CPC B62D 13/06; B60W 30/06; B62D 15/028; B60W 10/10; B60W 10/18; B60W 10/20; B60W 2050/146; B60W 2300/14

(57) ABSTRACT

A parking assistance device that can accurately set an appropriate turning position with less processing load as compared with the related art when calculating a travel trajectory for parking a towing vehicle connected with a towed vehicle is provided. Specifically, when calculating a travel trajectory for parking a towing vehicle connected with a towed vehicle, a parking start position and a parking target position are obtained, a plurality of candidate turning positions are set on a forward trajectory for moving forward from the parking start position, backward trajectories are calculated for the respective plurality of candidate turning positions when backward movement is assumed to be started from the candidate turning positions set on the forward trajectory, the calculated backward trajectories are compared for the respective plurality of candidate turning positions, and a turning position is set based on the comparison result.

### CROSS-REFERENCE TO RELATED APPLICATIONS

This is a National Stage of International Application No. PCT/JP 2024/010876 filed Mar. 20, 2024, claiming priority based on Japanese Patent Application No. 2023-073198 filed Apr. 27, 2023.

### TECHNICAL FIELD

The present disclosure relates to a parking assistance device that performs parking assistance of a vehicle.

### BACKGROUND ART

In related art, as parking assistance of a vehicle, there has been known to calculate a travel trajectory for parking and perform guidance and vehicle control such that parking is performed according to the calculated travel trajectory. Here, a travel trajectory particularly for performing backward parking is a travel trajectory in which forward movement is once performed to an appropriate turning position for entering a parking target position as a parking target such as a parking space, the forward movement is switched to backward movement at the turning position, and the backward movement is performed to the parking target position, but when providing the above-described parking assistance to a towing vehicle (tractor) towing a towed vehicle (trailer), it is necessary to set the above-described turning position taking into consideration not only a behavior of the towing vehicle but also a behavior of the towed vehicle.

For example, JP2022-107175A proposes a technique in which after generating a target route for a towing vehicle and a towed vehicle when parking is performed while the towing vehicle is towing the towed vehicle based on a parking start position, a parking target position, and an obstacle position, it is determined whether a maximum curvature of the generated target route for the towed vehicle is equal to or less than a maximum curvature at which the towed vehicle can turn, and when the maximum curvature is not equal to or less than the maximum curvature at which the towed vehicle can turn, a turning position is reset to correct the target route.

### CITATION LIST

### Patent Literature

PTL 1: JP2022-107175A (paragraphs 0059 to 0060)

### SUMMARY OF THE DISCLOSURE

Here, regarding the curvature of the travel trajectory of the towed vehicle when the towing vehicle towing the towed vehicle is moving backward, since the towed vehicle does not have a steering device, the curvature of the travel trajectory of the towed vehicle is determined mainly based on a connection angle (hitch angle) between the towing vehicle and the towed vehicle, as illustrated in FIG. 7. That is, as illustrated in the upper diagram in FIG. 7, when the connection angle between a towing vehicle 2 and a towed vehicle 3 is 0 degrees (positioned in a straight line), the curvature of the travel trajectory of the towed vehicle 3 when pushed by the towing vehicle 2 moving backward is 0. On the other hand, as illustrated in the lower diagram in FIG. 7, when the connection angle between the towing vehicle 2 and the towed vehicle 3 is not 0 degrees, the curvature of the travel trajectory of the towed vehicle 3 when pushed by the towing vehicle 2 moving backward is also not 0.

That is, depending on the connection angle at the time of turning, the travel trajectory of the towed vehicle when moving backward thereafter changes, but the connection angle is not constant during the process of moving forward to the turning position, and further, the connection angle at the start of forward movement is not necessarily 0 degrees. When the timing of turning changes, the connection angle at the time of turning also changes, and not only a start point but also the curvature of the travel trajectory for the subsequent backward movement also changes, and thus it is extremely difficult to set an appropriate turning position.

As in PTL 1, after the entire travel trajectory from the parking start position to the parking target position is generated once, the suitability of the generated travel trajectory can be determined and corrected. However, with such a method, it is necessary to repeatedly generate, evaluate, and correct the travel trajectory in order to set an appropriate turning position, and a travel trajectory that exceeds an allowable correction range cannot be corrected.

The aspects of the disclosure have been made in order to solve the problems in the related art, and an object of the disclosure is to provide a parking assistance device that can accurately set an appropriate turning position with less processing load as compared with the related art when calculating a travel trajectory for parking a towing vehicle connected with a towed vehicle.

### Solution to Problem

In order to achieve the above object, a parking assistance device according to the disclosure is a parking assistance device for assisting in parking a towing vehicle and a towed vehicle to be towed by the towing vehicle when the towing vehicle and the towed vehicle are connected. The parking assistance device includes: a parking start position acquiring unit configured to acquire a parking start position; a parking target position acquiring unit configured to acquire a parking target position; and a travel trajectory generation unit configured to generate a travel trajectory from the parking start position to the parking target position. The travel trajectory includes a forward section in which forward movement is performed from the parking start position according to a set forward trajectory and a backward section in which backward movement is performed from a turning position set on the forward trajectory to the parking target position. The travel trajectory generation unit sets a plurality of candidate turning positions on the forward trajectory of the towing vehicle in the forward section, calculates, for the respective plurality of candidate turning positions, travel trajectories of the towed vehicle as backward trajectories when the backward movement is assumed to be started from the candidate turning positions set on the forward trajectory of the towing vehicle, and compares the calculated backward trajectories of the towed vehicle for the respective plurality of candidate turning positions, and sets the turning position based on a comparison result.

### Advantageous Effects of Various Aspects of the Disclosure

According to the parking assistance device according to the disclosure having the above configuration, when calculating a travel trajectory for parking a towing vehicle connected with a towed vehicle, a plurality of candidate turning positions are set on a forward trajectory for moving forward from a parking start position, and a turning position is set by comparing backward trajectories when backward movement is assumed to be started from each candidate turning position, and thus an appropriate turning position can be accurately set with less processing load as compared with the related art.

### BRIEF DESCRIPTION OF DRAWINGS

FIG. 1 is a diagram illustrating a towing vehicle and a towed vehicle according to the present embodiment.

FIG. 2 is an enlarged view of the vicinity of a towing device of the towing vehicle. FIG. 3 is a diagram illustrating movement of the towing vehicle and the towed vehicle when a hitch ball and a coupler are connected.

FIG. 4 is a block diagram illustrating a configuration of a parking assistance device according to the present embodiment.

FIG. 5 is a flowchart of a parameter specifying processing program according to the present embodiment.

FIG. 6 is a diagram illustrating a virtual parking situation set for calculating a recommended parameter.

FIG. 7 is a diagram illustrating a relationship between a connection angle and a curvature of a travel trajectory of the towed vehicle.

FIG. 8 is a diagram illustrating a counter steering operation and an incremental steering operation.

FIG. 9 is a diagram illustrating transitions of curvatures of travel trajectories of the towing vehicle and the towed vehicle during a process of the counter steering operation and the incremental steering operation in the towing vehicle.

FIG. 10 is a diagram illustrating a relationship between the curvature of the travel trajectory of the towing vehicle and an incremental steering curvature gradient α of the travel trajectory of the towed vehicle during the counter steering operation of the towing vehicle.

FIG. 11 is a diagram illustrating a relationship between the curvature of the travel trajectory of the towing vehicle and a steering return curvature gradient β of the travel trajectory of the towed vehicle during the incremental steering operation of the towing vehicle.

FIG. 12 is a diagram illustrating a method for calculating a total length of a route required for parking.

FIG. 13 is a diagram illustrating a relationship between a trailer wheelbase and a specified parameter.

FIG. 14 is a flowchart of a parking assistance processing program according to the present embodiment.

FIG. 15 is a diagram illustrating an example of a forward trajectory from a parking start position.

FIG. 16 is a diagram illustrating candidate turning positions set on the forward trajectory.

FIG. 17 is a diagram illustrating a relationship between an initial curvature of a backward trajectory and a connection angle at a turning position.

FIG. 18 is a diagram illustrating a relationship between the initial curvature of the backward trajectory and the connection angle at the turning position.

FIG. 19 is a diagram illustrating an example of a backward trajectory calculated for the candidate turning position.

FIG. 20 is a diagram in which respective backward trajectories calculated for a plurality of candidate turning position are compared.

FIG. 21 is a diagram illustrating a method for correcting the candidate turning position.

### DESCRIPTION OF EMBODIMENTS

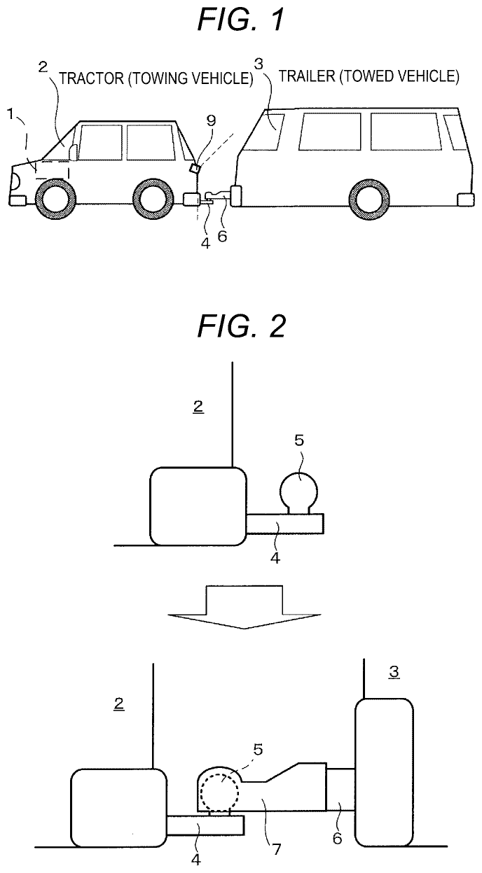

Hereinafter, a parking assistance device according to an embodiment of the disclosure will be described in detail with reference to the drawings. First, a towing vehicle (tractor) 2 equipped with a parking assistance device 1 according to the present embodiment and a towed vehicle (trailer) 3 towed by the towing vehicle 2 will be described below. FIG. 1 is a diagram illustrating the towing vehicle 2 and the towed vehicle 3.

Here, the towing vehicle 2 is also called a tractor, and can travel while towing the towed vehicle 3. The towing vehicle 2 may be, for example, an automobile (an internal combustion engine automobile) using an internal combustion engine (an engine, or the like) as a drive source, an automobile (an electric automobile, a fuel cell automobile, or the like) using an electric motor (a motor or the like) as a drive source, or an automobile (a hybrid automobile) using both of the internal combustion engine and the electric motor as a drive source. The vehicle type is not limited, and the towing vehicle 2 may be a standard vehicle or a large commercial tractor (trailer head) as long as the towing vehicle 2 is equipped with a towing device 4 described below.

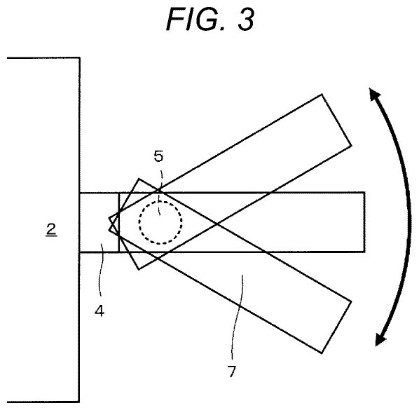

As illustrated in FIG. 1, the towing device 4 (hitch) that tows the towed vehicle 3 is disposed to protrude from a lower portion of, for example, a central portion of a rear bumper of the towing vehicle 2 in a vehicle width direction. FIG. 2 is an enlarged view of the vicinity of the towing device 4.

As illustrated in FIG. 2, the towing device 4 is fixed to, for example, a frame of the towing vehicle 2. As an example, the towing device 4 includes a hitch ball 5 having a spherical tip end portion erected in a vertical direction (vehicle up-down direction), and a coupler 7 provided at a tip end portion of a connection member 6 fixed to the towed vehicle 3 covers the hitch ball 5, so that the hitch ball 5 and the coupler 7 are connected, and as a result, the towing vehicle 2 and the towed vehicle 3 are connected. Shapes of the hitch ball 5 and the coupler 7 are not limited to shapes illustrated in FIG. 2, and the shape may be any shape as long as the towing vehicle 2 and the towed vehicle 3 can be connected.

When the hitch ball 5 and the coupler 7 are connected, the hitch ball 5 transmits forward, backward, leftward, and rightward movement to the towed vehicle 3 (connection member 6) in accordance with the movement of the towing vehicle 2. As illustrated in FIG. 3, even when the coupler 7 is connected to the hitch ball 5, an angle of the coupler 7 with respect to the hitch ball 5 can be freely changed (with an upper limit), and the towed vehicle 3 can swing (turn) in the vehicle width direction with respect to the towing vehicle 2.

On the other hand, as illustrated in FIG. 1, a rear camera (imaging device) 9 is installed on a wall portion of a rear hatch on a rear side of the towing vehicle 2. The rear camera 9 is, for example, a digital camera including an imaging element such as a CCD or a CIS. The rear camera 9 can output video data (captured image data) at a predetermined frame rate. The rear camera 9 has a wide-angle lens or a fisheye lens, an optical axis direction is set to face diagonally downward, and which can capture an image in a range of, for example, 140° to 220° in a horizontal direction.

The imaging range of the rear camera 9 includes at least the towing device 4 and the hitch ball 5 at a rear end portion of the towing vehicle 2. The image data captured by the rear camera 9 can be used to detect, for example, a connection state (for example, a connection angle (hitch angle), presence or absence of connection, or the like) between the towing vehicle 2 and the towed vehicle 3. Instead of the rear camera 9, a sensor installed in the towing device 4 may be provided as a unit for detecting the connection state between the towing vehicle 2 and the towed vehicle 3.

On the other hand, the towed vehicle 3 is also called a trailer and travels while being towed by the towing vehicle 2. Therefore, unlike the towing vehicle 2, the towed vehicle 3 basically does not include an engine or a motor as a drive source. A steering device (steering system) for changing a direction of wheels is not provided. For example, a camping trailer having a living space inside, and a light trailer carrying a car or a ship are applicable. The towed vehicle 3 includes a main body portion, a plurality of (two in the present embodiment) trailer wheels, the connection member 6, and the coupler 7.

Here, as illustrated in FIG. 1, the connection member 6 is provided at a lower portion of a central portion of the main body portion of the towed vehicle 3 in a vehicle width direction, and is disposed to protrude forward (in a travel direction) from a front end portion of the main body portion.

As illustrated in FIG. 2, the coupler 7 is provided at a front end portion of the connection member 6, and a spherical concave portion covering the hitch ball 5 is formed. When the coupler 7 covers the hitch ball 5, the towed vehicle 3 is connected to the towing vehicle 2 in a turnable manner as described above (see FIG. 3). A length of the connection member 6 and a height thereof from a ground surface (that is, a position of the coupler 7 in the towed vehicle 3) vary depending on the type of the towed vehicle 3. In the present embodiment, the coupler 7 is positioned at least at a position at which the coupler 7 can be connected to the hitch ball 5 provided in the towing vehicle 2.

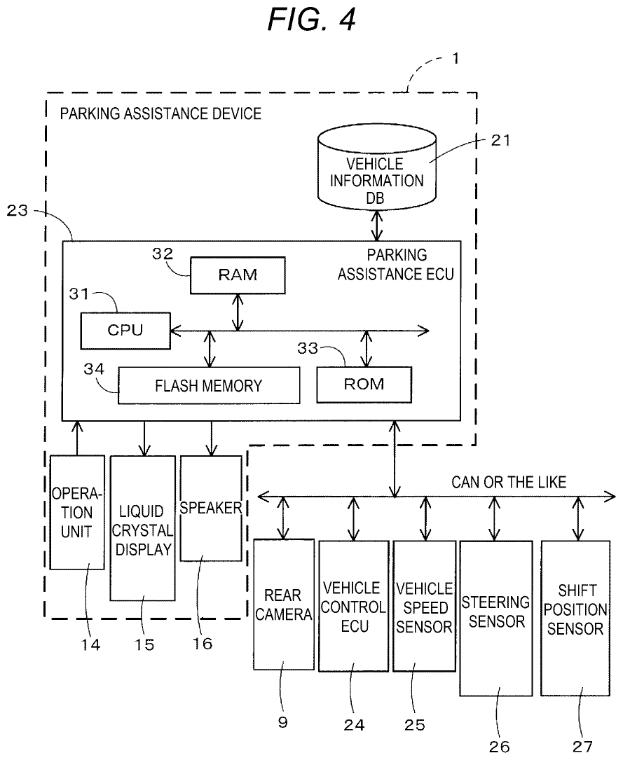

Subsequently, the parking assistance device 1 provided on the towing vehicle 2 will be described. The parking assistance device 1 is a device for assisting a vehicle operation performed by a driver when parking the towing vehicle 2 connected with the towed vehicle 3 into a specified parking space. FIG. 4 is a block diagram illustrating a configuration of the parking assistance device 1 according to the present embodiment.

As illustrated in FIG. 4, the parking assistance device 1 according to the present embodiment includes an operation unit 14 that receives an operation from an occupant of the towing vehicle 2, a liquid crystal display 15 that displays, to the occupant of the towing vehicle 2, a travel trajectory for parking in a parking space and other pieces of information on parking assistance, a speaker 16 that outputs voice guidance related to parking assistance, vehicle information DB 21 in which various types of data related to the towing vehicle 2 and the towed vehicle 3 are recorded, and a parking assistance ECU 23 that performs various types of calculation processing based on the input information. The parking assistance device 1 is also connected, via an in-vehicle network such as a CAN, to the rear camera 9 installed on the towing vehicle 2, a vehicle control ECU 24 that performs various types of control on the towing vehicle 2, and various sensors such as a vehicle speed sensor 25, a steering sensor 26, and a shift position sensor 27.

The operation unit 14 is provided on an instrument panel or a steering wheel of the towing vehicle 2, is operated, for example, when a transition operation to a parking assistance mode to be described later is performed or when various parameters related to the towing vehicle 2 or the towed vehicle 3 are input, and includes a plurality of operation switches (not illustrated) such as various keys and buttons. The parking assistance ECU 23 performs control to execute various corresponding operations based on a switch signal output by pressing each switch or the like. The operation unit 14 may include a touch panel provided on a front surface of the liquid crystal display 15. A microphone and a voice recognition device may be further provided.

The liquid crystal display 15 is provided on the instrument panel of the towing vehicle 2, and displays a travel trajectory for parking and the like when transitioning to the parking assistance mode that assists in parking with the towing vehicle 2 connected with the towed vehicle 3. In the case where a parking operation is to be performed by a user rather than automatically, an operation instruction of steering for traveling along a travel trajectory, or an operation instruction of a brake, an accelerator, or a shift position is also displayed. The liquid crystal display 15 may also be used in a navigation device.

The speaker 16 outputs voice guidance or the like for guiding a parking operation at the time of transitioning to the parking assistance mode based on an instruction from the parking assistance ECU 23. The speaker 16 may also be used in a navigation device.

The vehicle information DB 21 is a storage unit that stores various types of information on the towing vehicle 2 and the towed vehicle 3. For example, with respect to the towing vehicle 2, an installation position of the hitch ball 5 (a height from the ground surface, a position in a left-right direction, a distance from a vehicle rear end), a total length, a vehicle width, a wheelbase, a minimum turning radius, and the like are stored. A distance from a rear wheel shaft of the towing vehicle 2 to a connection point between the towing vehicle 2 and the towed vehicle 3 (the position of the hitch ball 5) is also stored. On the other hand, with respect to the towed vehicle 3, an installation position of the coupler 7 (a height from the ground surface, a position in the left-right direction, a distance from a vehicle tip end), a total length, a vehicle width, a minimum turning radius, and the like are stored. A distance (corresponding to a trailer wheelbase) from a rotation center of the towed vehicle 3 to the connection point between the towing vehicle 2 and the towed vehicle 3 (the position of the hitch ball 5) is also stored. When the towed vehicle 3 has one axle (two wheels), the rotation center of the towed vehicle 3 is an axle center. On the other hand, when the towed vehicle 3 has two axes (four wheels), the rotation center exists between the two axles. The pieces of information may be input in advance by an occupant or a person from the vehicle manufacturer using the operation unit 14, or values detected by the rear camera 9 or various sensors may be automatically input. The towed vehicle 3 to be towed is not necessarily fixed, and thus when the towed vehicle 3 to be towed changes, the above parameters must also change. As a storage medium of the vehicle information DB 21, for example, a memory card can be used. Further, the storage medium may be provided in a storage area (for example, RAM or flash memory) in the parking assistance ECU 23.

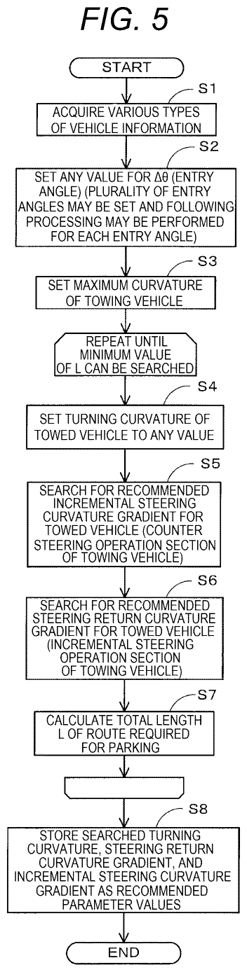

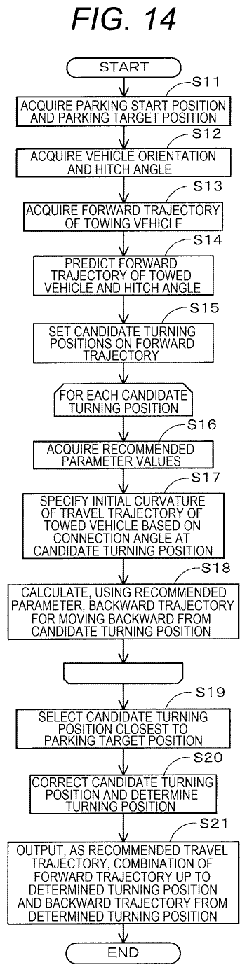

On the other hand, the parking assistance ECU (electronic control unit) 23 is an electronic control unit that performs overall control of the parking assistance device 1, and includes a CPU 31 serving as a calculation device and a control device, and an internal storage device such as a RAM 32 that is used as a working memory when the CPU 31 performs various types of calculation processing and that stores route data and the like when a route is searched, a ROM 33 that records a control program, a parameter specifying processing program (see FIG. 5) and a parking assistance program (see FIG. 14) to be described later, and a flash memory 34 that stores a program read out from the ROM 33. The parking assistance ECU 23 includes various control units as a processing algorithm. For example, a parking start position acquiring unit acquires a parking start position. A parking target position acquiring unit acquires a parking target position. A travel trajectory generation unit generates a travel trajectory from the parking start position to the parking target position.

The vehicle control ECU 24 is an electronic control unit that controls the towing vehicle 2. The vehicle control ECU 24 is connected to each drive unit of the vehicle such as a steering, a brake, an accelerator, and a transmission, and in the present embodiment, for example, when transitioning to the parking assistance mode that assists in parking into a parking space to be described later, automatic driving assistance for the towing vehicle 2 can be implemented by controlling each drive unit. Specifically, the parking assistance ECU 23 transmits various types of assistance information on the automatic driving assistance generated by the parking assistance device 1 to the vehicle control ECU 24 via the CAN when the parking assistance mode is executed. The vehicle control ECU 24 uses the received various types of assistance information to execute the automatic driving assistance after start of traveling. The assistance information includes, for example, a travel trajectory recommended for traveling of the towing vehicle 2 or the towed vehicle 3, and information indicating a vehicle speed or a steering angle when traveling along the travel trajectory. In the automatic driving assistance, only the steering operation may be automatically performed, or the drive source, the brake, and the transmission may be automatically controlled. On the other hand, it is not essential for the towing vehicle 2 to be equipped with the above-described automatic driving assistance, and the towing vehicle 2 may be a vehicle that can only be driven manually. In this case, when transitioning to the parking assistance mode, instead of the above-described automatic driving assistance, steering operation guidance, a brake, an accelerator, and shift position operation guidance are provided are provided to travel along the recommended travel trajectory.

The vehicle speed sensor 25 is an active wheel speed sensor attached to a wheel of the towing vehicle 2, detects a rotation speed of the wheel, and outputs a speed signal. The steering sensor 26 is attached inside the steering device, detects a steering angle when the steering wheel is turned, and outputs a steering angle signal. Further, the shift position sensor 27 is built into a shift lever, and detects which of “P (parking)”, “N (neutral)”, “R (reverse)”, “D (drive)”, “2 (second gear)”, and “L (low)” the shift position is.

The parking assistance ECU 23 can acquire a current vehicle speed, traveling distance, steering angle, shift position, and the like of the towing vehicle 2 based on the output signals from the various sensors.

Subsequently, a parameter specifying processing program executed by the parking assistance ECU 23 in the parking assistance device 1 having the above-described configuration will be described with reference to FIG. 5. FIG. 5 is a flowchart of the parameter specifying processing program according to the present embodiment. Here, the parameter specifying processing program is executed when a predetermined initial setting operation is received at the operation unit 14 while an accessory power supply (ACC power supply) of the towing vehicle 2 is turned on, and is a program for deriving recommended values of parameters to be used for generating a travel trajectory for parking. The program illustrated in the flowchart in FIG. 5 is stored in the RAM 32 or the ROM 33 of the parking assistance device 1 and is executed by the CPU 31.

First, in step (hereinafter abbreviated as S) 1, the CPU 31 acquires information on the towing vehicle 2 and the towed vehicle 3 from the vehicle information DB 21. In the vehicle information DB 21, various types of information on the towing vehicle 2 and the towed vehicle 3 are stored, and in particular, at least the “minimum turning radius”, the “distance from the rear wheel shaft of the towing vehicle 2 to the connection point between the towing vehicle 2 and the towed vehicle 3 (the position of the hitch ball 5) (hereinafter referred to as a connection distance)” for the towing vehicle 2, and the “distance from the connection point between the towing vehicle 2 and the towed vehicle 3 to a front wheel shaft of the towed vehicle 3 (hereinafter referred to as a trailer wheelbase)” for the towed vehicle 3 are acquired in S1.

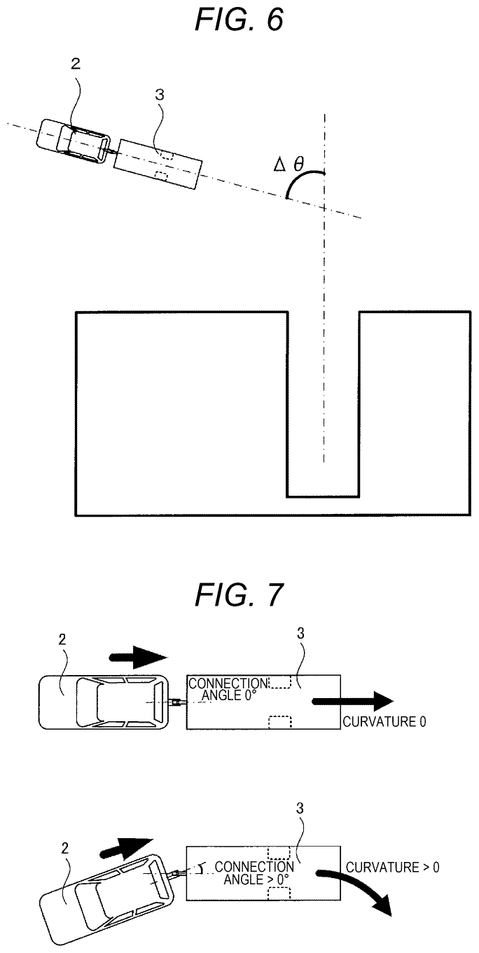

Next, in S2, the CPU 31 sets a virtual parking situation as illustrated in FIG. 6 in order to derive recommended parameter values. In particular, in S2, any value is set as an entry angle Δθ to a parking space (also corresponding to an angle amount required to turn to enter the parking space). The entry angle Δθ may be set to, for example, 30 degrees, 60 degrees, or 90 degrees. A plurality of angles may be set as the entry angle Δθ, and in this case, the following processing is executed for each set entry angle Δθ, and the parameter is calculated for each Δθ.

Subsequently, in S3, the CPU 31 sets a maximum curvature allowed for the travel trajectory of the towing vehicle 2 based on the minimum turning radius of the towing vehicle 2 acquired in S1. In particular, as the maximum curvature, a first maximum curvature allowed for a travel trajectory in which the towing vehicle 2 turns in a direction same as that of the towed vehicle 3 (rightward direction along a backward direction in the example illustrated in FIG. 6) and a second maximum curvature allowed for a travel trajectory in which the towing vehicle 2 turns in a direction different from that of the towed vehicle 3 (leftward direction along the backward direction in the example illustrated in FIG. 6) are set, and further the second maximum curvature is set to a value smaller than that of the first maximum curvature. For example, the first maximum curvature is a curvature of a trajectory when the towing vehicle 2 turns with the minimum turning radius, and the second maximum curvature is 3/4 of the first maximum curvature. As an example, the first maximum curvature is 0.2[1 /m], and the second maximum curvature is 0.15[1 /m].

Thereafter, in S4, the CPU 31 sets a turning curvature of the towed vehicle 3 to any value when parking is performed in the virtual parking situation set in S2. The turning curvature corresponds to a maximum value of the curvature (maximum curvature) of the travel trajectory of the towed vehicle 3.

Here, regarding the curvature of the travel trajectory of the towed vehicle 3 when the towing vehicle 2 towing the towed vehicle 3 is moving backward, since the towed vehicle 3 does not have a steering device, the curvature of the travel trajectory of the towed vehicle 3 is determined mainly based on the connection angle between the towing vehicle 2 and the towed vehicle 3 as illustrated in FIG. 7. That is, as illustrated in the upper diagram in FIG. 7, when the connection angle between the towing vehicle 2 and the towed vehicle 3 is 0 degrees (positioned in a straight line), the curvature of the travel trajectory of the towed vehicle 3 when pushed by the towing vehicle 2 moving backward is 0. On the other hand, as illustrated in the lower diagram in FIG. 7, when the connection angle between the towing vehicle 2 and the towed vehicle 3 is larger than 0 degrees, the curvature of the travel trajectory of the towed vehicle 3 when pushed by the towing vehicle 2 moving backward is larger than 0. As the connection angle between the towing vehicle 2 and the towed vehicle 3 increases, the curvature of the travel trajectory of the towed vehicle 3 increases (the turning radius decreases).

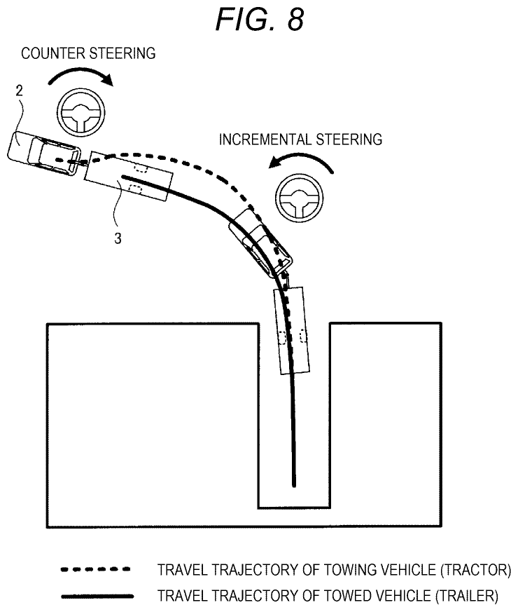

When the towing vehicle 2 towing the towed vehicle 3 moves backward for parking, it is important to increase the curvature of the travel trajectory of the towed vehicle 3 in as short a time as possible in order to shorten a total length of the route required for parking. Therefore, as illustrated in FIG. 8, it is common practice to first perform a counter steering operation in which the towing vehicle 2 is deliberately steered in an opposite direction (rightward direction in FIG. 8) to an original turning direction (leftward direction in FIG. 8 since the driver intends to turn toward a left-rearward direction) immediately after the start of the backward movement, and then steered in the original turning direction. On the other hand, it is necessary to bring the connection angle between the towing vehicle 2 and the towed vehicle 3 close to 0 degrees when approaching to the parking target position, but in order to shorten the total length of the route required for parking, it is effective to maintain a state in which the curvature is as large as possible to the end without gradually reducing the curvature, and to quickly reduce the curvature at the end, and thus, it is common practice to perform an incremental steering operation of increasing steering in the turning direction at the end of the turn.

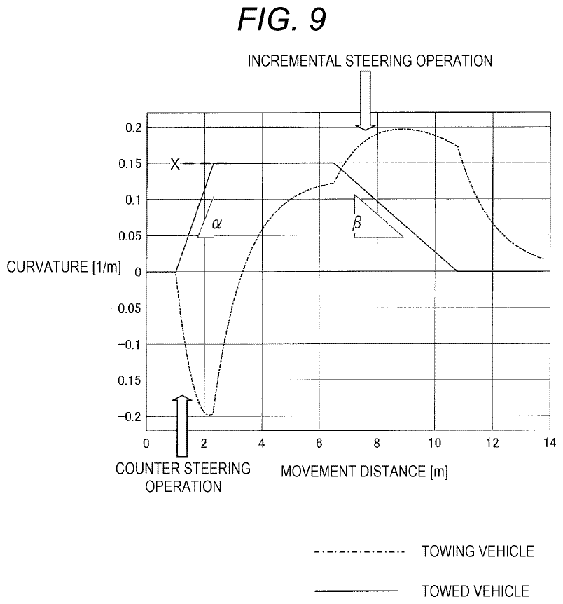

When the counter steering operation and the incremental steering operation are performed in the towing vehicle 2, the curvatures of the travel trajectories of the towing vehicle 2 and the towed vehicle 3 show a transition as illustrated in FIG. 9, for example. That is, the curvature of the travel trajectory of the towed vehicle 3 increases from 0, which is an initial curvature at the start of the backward movement, to a turning curvature X at a predetermined increase rate (gradient) α by performing the counter steering operation in the towing vehicle 2 (first section). Then, after performing the backward movement by a predetermined distance while maintaining the turning curvature, the curvature of the travel trajectory of the towed vehicle 3 decreases from the turning curvature X to 0 at a predetermined decrease rate (gradient) β by performing the incremental steering operation in the towing vehicle 2 (second section). In the example illustrated in FIG. 9, α and β are constant values with respect to the movement distance (straight line graph), but may be values that vary with the movement distance (curved line graph). In the virtual parking situation set in S2, it is assumed that the connection angle between the towing vehicle 2 and the towed vehicle 3 is 0 degrees (positioned in a straight line) at the start of the backward movement, but when it is assumed that the connection angle between the towing vehicle 2 and the towed vehicle 3 is other than 0 degrees at the start of the backward movement, an initial value of the curvature of the travel trajectory of the towed vehicle 3 is other than 0.

In S4, the CPU 31 first provisionally sets any value as the turning curvature X in order to search for a recommended value of the turning curvature X illustrated in FIG. 9. As described later, a total length L of the route required for parking using the turning curvature X provisionally set in S4 is checked to determine whether the provisionally set turning curvature is a recommended value.

Subsequently, in S5, the CPU 31 searches for a recommended incremental steering curvature gradient of the towed vehicle 3 when parking is performed in the virtual parking situation set in S2. The incremental steering curvature gradient is an increase rate (an increase value of the curvature per unit traveling distance) when the curvature of the travel trajectory of the towed vehicle 3 is increased by the counter steering operation of the towing vehicle 2, and is a value of a illustrated in FIG. 9.

Hereinafter, a method for searching for a recommended value of the incremental steering curvature gradient α will be described.

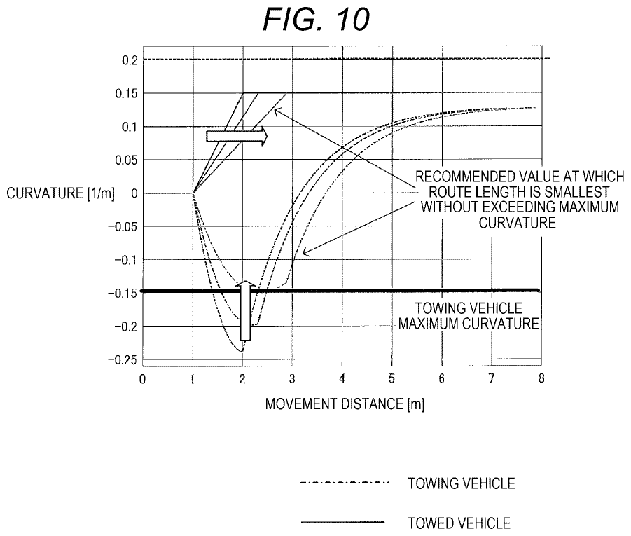

FIG. 10 is a diagram illustrating a relationship between the curvature of the travel trajectory of the towing vehicle 2 and the incremental steering curvature gradient α of the travel trajectory of the towed vehicle 3 during the counter steering operation of the towing vehicle 2. The curvature of the travel trajectory illustrated in FIG. 10 can be derived by calculating possible travel trajectories of the towing vehicle 2 and the towed vehicle 3, respectively, using a trailer wheelbase which is the distance from the rotation center of the towed vehicle 3 to the connection point that is acquired in S1 and the distance from the rear wheel shaft of the towing vehicle 2 to the connection point between the towing vehicle 2 and the towed vehicle 3 with respect to the virtual parking situation set in S2, and extracting the curvature from the calculated travel trajectories. As illustrated in FIG. 10, the greater the curvature in a negative direction during the counter steering operation of the towing vehicle 2, the greater the incremental steering curvature gradient α of the travel trajectory of the towed vehicle 3. On the other hand, it is estimated that the greater the incremental steering curvature gradient α, the shorter the distance required for the towed vehicle 3 to turn, and therefore the total length of the route required for parking is smaller. Therefore, as illustrated in FIG. 10, the curvature of the towing vehicle 2 during the counter steering operation is displaced in a stepwise manner, and a maximum value of the incremental steering curvature gradient α is searched for under the condition that the travel trajectory of the towing vehicle 2 does not exceed the maximum curvature set in S3. Specifically, the incremental steering curvature gradient α of the travel trajectory of the towed vehicle 3 that corresponds to a case where the travel trajectory of the towing vehicle 2 has the maximum curvature (for example, −0.15 [1/m] in the example illustrated in FIG. 10) set in S3 is a recommended value. In a case where a steering angular velocity limit value is exceeded when moving backward at an assumed backward vehicle speed (for example, 4 km/h) using the searched incremental steering curvature gradient α, the incremental steering curvature gradient α is reduced to a value that does not exceed the steering angular velocity limit value.

Subsequently, in S6, the CPU 31 searches for a recommended steering return curvature gradient of the towed vehicle 3 when parking is performed in the virtual parking situation set in S2. The steering return curvature gradient is a decrease rate (a decrease value of the curvature per unit traveling distance) when the curvature of the travel trajectory of the towed vehicle 3 is decreased by the incremental steering operation of the towing vehicle 2, and is a value of β illustrated in FIG. 9.

Hereinafter, a method for searching for a recommended value of the steering return curvature gradient β will be described.

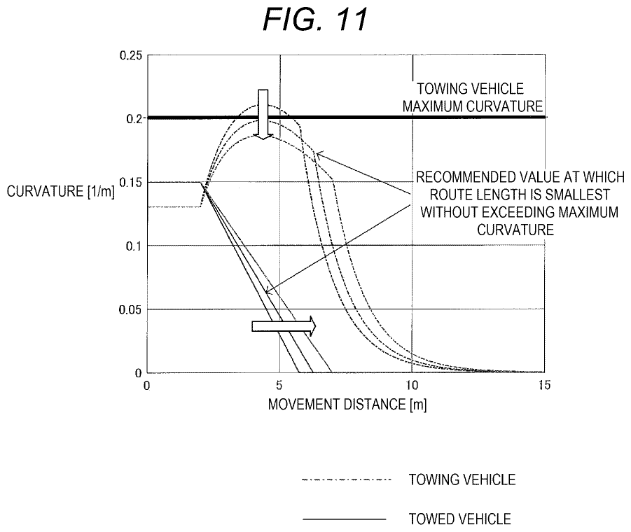

FIG. 11 is a diagram illustrating a relationship between the curvature of the travel trajectory of the towing vehicle 2 and the steering return curvature gradient β of the travel trajectory of the towed vehicle 3 during the incremental steering operation of the towing vehicle 2. The curvature of the travel trajectory illustrated in FIG. 11 can be derived by calculating possible travel trajectories of the towing vehicle 2 and the towed vehicle 3, respectively, using a trailer wheelbase which is the distance from the rotation center of the towed vehicle 3 to the connection point that is acquired in S1 and the distance from the rear wheel shaft of the towing vehicle 2 to the connection point between the towing vehicle 2 and the towed vehicle 3 with respect to the virtual parking situation set in S2, and extracting the curvature from the calculated travel trajectories. As illustrated in FIG. 11, the greater the curvature in a positive direction during the incremental steering operation of the towing vehicle 2, the greater the steering return curvature gradient β of the travel trajectory of the towed vehicle 3. On the other hand, it is estimated that the greater the steering return curvature gradient β, the shorter the distance required for the towed vehicle 3 to turn, and therefore the total length of the route required for parking is shorter. Therefore, as illustrated in FIG. 11, the curvature of the towing vehicle 2 during the incremental steering operation is displaced in a stepwise manner, and a maximum value of the steering return curvature gradient β is searched for under the condition that the travel trajectory of the towing vehicle 2 does not exceed the maximum curvature set in S3. Specifically, the steering return curvature gradient β of the travel trajectory of the towed vehicle 3 that corresponds to a case where the travel trajectory of the towing vehicle 2 has the maximum curvature (for example, +0.2 [1/m] in the example illustrated in FIG. 11) set in S3 is a recommended value. In a case where a steering angular velocity limit value is exceeded when moving backward at an assumed backward vehicle speed (for example, 4 km/h) using the searched steering return curvature gradient β, the steering return curvature gradient β is reduced to a value that does not exceed the steering angular velocity limit value.

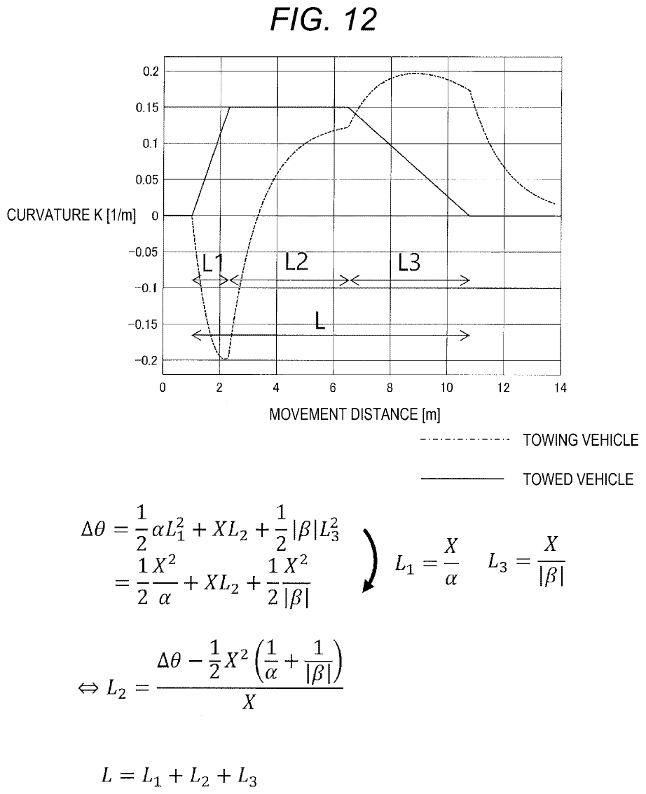

Thereafter, in S7, the CPU 31 calculates the total length L of the route required for parking in order to determine whether each of the values provisionally set and searched for in S4 to S6 is a recommended value. The L may be calculated based on either the travel trajectory of the towing vehicle 2 or the travel trajectory of the towed vehicle 3. For example, when calculating the L based on the travel trajectory of the towed vehicle 3, calculation is performed according to a formula illustrated in FIG. 12.

Similarly, a value of the turning curvature X freely set in S4 is appropriately changed, and the processing in S4 to S7 is repeatedly performed. Then, the recommended values of the turning curvature X, the incremental steering curvature gradient α, and the steering return curvature gradient β are respectively specified, with priority given to shortening the overall length L of the route required for parking. Specifically, a combination of the turning curvature X, the incremental steering curvature gradient α, and the steering return curvature gradient β at which the L calculated in S7 is minimized is searched for, and the combination of the turning curvature X, the incremental steering curvature gradient α, and the steering return curvature gradient β at which L is minimized is specified, and then each of the specified values is stored in the flash memory 34 or the like as a value recommended for use in generation of the travel trajectory (S8).

As the trailer wheelbase which is the distance from the rotation center of the towed vehicle 3 to the connection point that is used for deriving the recommended parameter in the present embodiment, the trailer wheelbase which is the distance from the rotation center of the towed vehicle 3 connected at the present time to the connection point is used, but a virtual trailer wheelbase may be used. For example, the trailer wheelbase may be set to 2 m, 2.5 m, 3 m, 3.5 m, and 4 m, and the parameter specifying processing program described above may be executed for each trailer wheelbase to derive the recommended parameters. Accordingly, it is not necessary to execute the above-described parameter specifying processing program every time the towed vehicle 3 to be connected is changed, and the parameter recommended for the towed vehicle 3 to be connected can be easily specified.

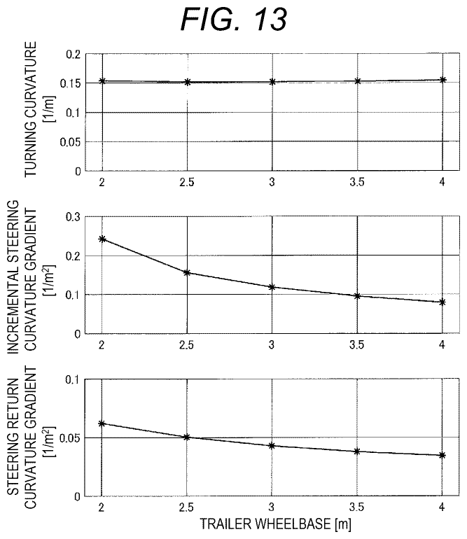

Here, FIG. 13 is a diagram illustrating a relationship between the trailer wheelbase and the parameters derived in S8. As illustrated in FIG. 13, when the trailer wheelbase of the towed vehicle 3 is in a range of 2 m to 4 m, the recommended turning curvature X is less affected by the trailer wheelbase of the towed vehicle 3, but the recommended incremental steering curvature gradient α and the recommended steering return curvature gradient β are derived as smaller values as the trailer wheelbase increases. As illustrated in FIG. 13, by performing linear interpolation, recommended parameters for trailer wheelbases other than 2 m, 2.5 m, 3 m, 3.5 m, and 4 m can be specified.

The same applies to the connection distance, and for example, in the present embodiment, the distance from the rear wheel shaft of the towing vehicle 2 to the connection point of the towing device 4 currently provided in the towing vehicle 2 is used, but a virtual connection distance may be used as in the case of the trailer wheelbase described above. For example, the connection distance may be set to 2 m, 2.5 m, 3 m, 3.5 m, and 4 m, and the parameter specifying processing program described above may be executed for each of the connection distances to derive the recommended parameters. Accordingly, it is not necessary to execute the above-described parameter specifying processing program every time the towing device 4 provided in the towing vehicle 2 is changed, and the parameter recommended for the towing device 4 provided in the towing vehicle 2 can be easily specified.

The parameters derived in S8 are recommended for a parking situation in which parking is performed by turning at a certain entry angle Δθ (for example, 60 degrees) set in S2, but the derived parameters can also be used as recommended parameters for a parking situation in which parking is performed at an entry angle (for example, 90 degrees or 45 degrees) other than the entry angle Δθ set in S2. A plurality of angles may be set as the entry angle Δθ, and a recommended parameter may be derived for each Δθ.

The CPU 31 uses the recommended values of the turning curvature X, the incremental steering curvature gradient α, and the steering return curvature gradient β derived in S8 to generate a travel trajectory of the towing vehicle 2 when actually parking, as described below.

Subsequently, a parking assistance processing program executed by the parking assistance ECU 23 in the parking assistance device 1 having the above-described configuration will be described with reference to FIG. 14. FIG. 14 is a flowchart of the parking assistance processing program according to the present embodiment. Here, the parking assistance processing program is a program that is executed when the driver of the towing vehicle 2 operates the operation unit 14 to select the transition to the parking assistance mode while the accessory power supply (ACC power supply) of the towing vehicle 2 is turned on, and is a program that assists the driver in a parking operation when parking with the towing vehicle 2 connected with the towed vehicle 3. The program illustrated in the flowchart in FIG. 14 is stored in the RAM 32 or the ROM 33 of the parking assistance device 1 and is executed by the CPU 31.

First, in S11, the CPU 31 acquires a parking start position and a parking target position. Basically, a current position of the towing vehicle 2 and the towed vehicle 3 is the parking start position, but when it is difficult to park from the current position to the parking target position, the parking start position may be set to a position different from the current position, and guidance to the parking start position may also be provided. On the other hand, regarding the parking target position, the user may designate a desired parking position from, for example, an image around the towing vehicle 2 displayed on the liquid crystal display 15, and the designated position may be set as the parking target position, or a camera or a sensor may be used to detect a parking space around the towing vehicle 2, and the detected parking space may be set as the parking target position.

Next, in S12, the CPU 31 acquires an orientation of the towing vehicle 2 and the towed vehicle 3 and the connection angle (hitch angle) between the towing vehicle 2 and the towed vehicle 3 at the parking start position. As described above, since the current position of the towing vehicle 2 and the towed vehicle 3 is basically the parking start position, the current orientation and the connection angle of the towing vehicle 2 and the towed vehicle 3 are acquired in S12. The connection angle can be specified from, for example, an image captured by the rear camera 9.

Subsequently, in S13, the CPU 31 acquires a forward trajectory of the towing vehicle 2 for moving forward from the parking start position acquired in S11 to the direction of the towing vehicle 2 acquired in S12 while turning in a direction away from the parking target position. Here, the travel trajectory particularly for performing backward parking includes a forward section in which forward movement is once performed to a turning position appropriate for entering a parking target position as a parking target such as a parking space, and a backward section in which the forward movement is switched to backward movement at a turning position and then the backward movement is performed to the parking target position. Hereinafter, the travel trajectory in the forward section is referred to as a forward trajectory, and the travel trajectory in the backward section is referred to as a backward trajectory. The forward trajectory of the towing vehicle 2 is basically a travel trajectory having a fixed shape that is prepared in advance, but in cases such as when a surrounding free space is insufficient, the prepared forward trajectory may be modified.

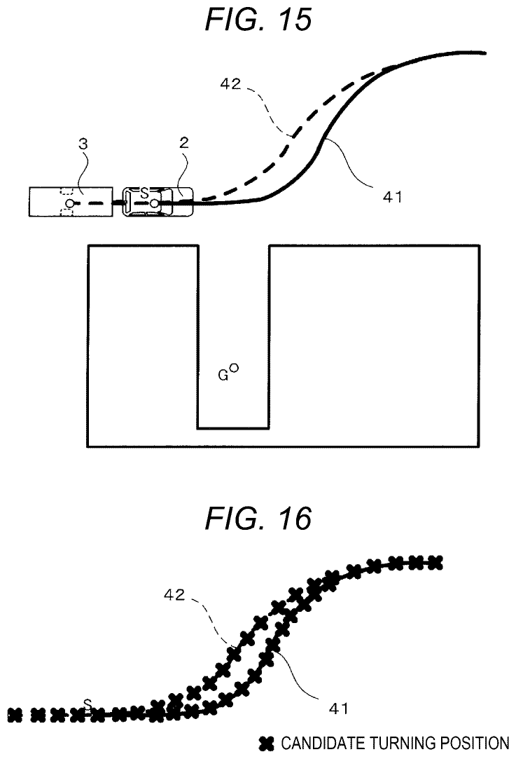

Here, FIG. 15 is a diagram illustrating an example of the forward trajectory of the towing vehicle 2 acquired in S13. As illustrated in FIG. 15, a forward trajectory 41 of the towing vehicle 2 is a trajectory in which the towing vehicle 2 moves diagonally forward and which is composed of a plurality of connected clothoid curves. For example, the forward trajectory 41 illustrated in FIG. 15 is a combination of a first clothoid curve in which forward movement is performed from a parking start position S while steering is gradually turned in a leftward direction (that is, while the curvature gradually changes to a larger value) and a second clothoid curve in which forward movement is performed while steering is gradually returned toward a straight direction (that is, while the curvature is gradually reduced). A direction of the lateral movement is a direction away from the parking target position G, and a length of the forward trajectory is set to a trajectory that allows movement at least farther than the parking target position G.

Thereafter, in S14, the CPU 31 predicts transition of the travel trajectory of the towed vehicle 3 and the connection angle (hitch angle) when the towing vehicle 2 moves along the forward trajectory acquired in S13, and acquires the predicted transition of the travel trajectory and the connection angle as the transition of the forward trajectory of the towed vehicle 3 and the connection angle during forward trajectory traveling. The transition of the travel trajectory of the towed vehicle 3 and the connection angle is predicted based on various types of information stored in the vehicle information DB 21 (for example, the distance from the rear wheel shaft of the towing vehicle 2 to the connection point between the towing vehicle 2 and the towed vehicle 3 (the position of the hitch ball 5), and the trailer wheelbase), the orientation of the towed vehicle 3 acquired in S12 and the connection angle. FIG. 15 also illustrates an example of a forward trajectory 42 of the towed vehicle 3 that is predicted when the towing vehicle 2 moves along the forward trajectory 41.

Next, in S15, the CPU 31 sets candidate turning positions on the respective forward trajectories acquired in S13 and S14, which are candidate positions at which the towing vehicle 2 and the towed vehicle 3 turn (switch from forward to backward). As illustrated in FIG. 16, a plurality of candidate turning positions are set from a start point to an end point of the forward trajectory at predetermined distance intervals (for example, 1 m intervals or 50 cm intervals). The intervals and the number of the set candidate turning positions can be changed as appropriate. Alternatively, the candidate turning positions may be set only in a range (near a center) that is particularly likely to be the turning positions, rather than from the start point to the end point of the forward trajectory. In the example illustrated in FIG. 16, the candidate turning positions are set for both the forward trajectory 41 of the towing vehicle 2 and the forward trajectory 42 of the towed vehicle 3, but the candidate turning positions may also be set only for the forward trajectory 41 of the towing vehicle 2 generated in S13.

The following processing in S16 to S18 is executed for each of the candidate turning positions set in S15, and backward trajectories of the towing vehicle 2 and the towed vehicle 3 when backward movement is assumed to be started from the candidate turning positions set on the forward trajectory in S15 are calculated as follows for the respective candidate turning positions. After the processing in S16 to S18 is executed for all the candidate turning positions set in S15, the process proceeds to S19.

Here, as described in the parameter specifying processing program (FIG. 5) described above, when the towing vehicle 2 towing the towed vehicle 3 moves backward for parking, the counter steering operation and the incremental steering operation are performed in the towing vehicle 2 (FIG. 8). As a result of performing the counter steering operation and the incremental steering operation in the towing vehicle 2, the curvatures of the travel trajectories of the towing vehicle 2 and the towed vehicle 3 show the transition as illustrated in FIG. 9 as an example. That is, the curvature of the travel trajectory of the towed vehicle 3 increases from the initial curvature (0 in FIG. 9) at the start of the backward movement to the turning curvature X at the predetermined increase rate (gradient) α by performing the counter steering operation in the towing vehicle 2 (first section). Then, after moving backward by a predetermined distance while maintaining the turning curvature, the curvature of the travel trajectory of the towed vehicle 3 decreases from the turning curvature X to 0 at the predetermined decrease rate (gradient) β by performing the incremental steering operation in the towing vehicle 2 (second section). In the above-described parameter specifying processing program (FIG. 5), the recommended values of the turning curvature X, the incremental steering curvature gradient α, and the steering return curvature gradient β are derived, and first, in S16, the CPU 31 reads and acquires these recommended values from the flash memory 34.

Subsequently, in S17, the CPU 31 specifies the connection angle (hitch angle) between the towing vehicle 2 and the towed vehicle 3 when located at the candidate turning position based on the transition of the connection angle between the towing vehicle 2 and the towed vehicle 3 when moving forward along the forward trajectory predicted in S14.

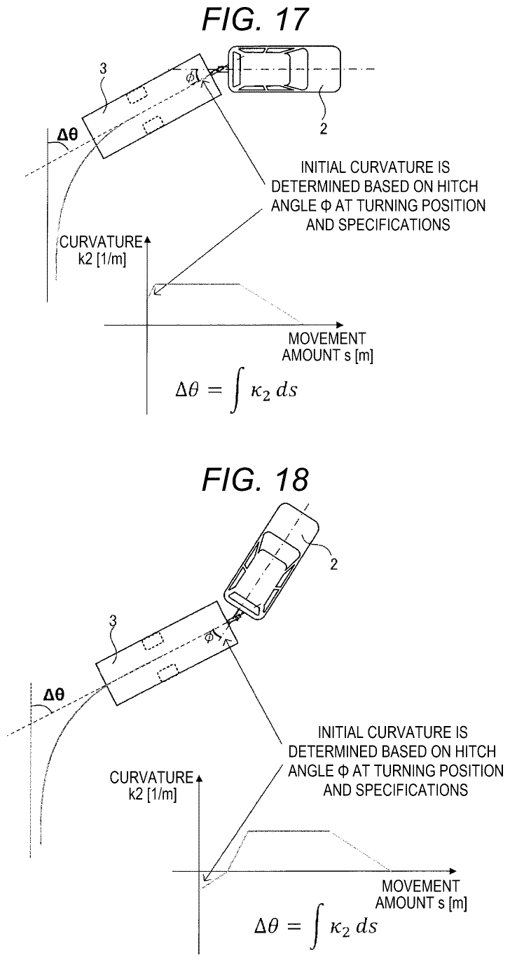

Here, the initial curvature of the travel trajectory of the towed vehicle 3 is determined based on the connection angle between the towing vehicle 2 and the towed vehicle 3 at the start of the backward movement, that is, at the time of turning. Specifically, as illustrated in FIG. 17, when the towing vehicle 2 faces toward the parking target position with respect to the travel direction of the towed vehicle 3 at the time of turning, the initial curvature is greater than 0 (a trajectory in which turning is started in a direction same as the turning direction to the parking target position), and as illustrated in FIG. 18, when the towing vehicle 2 faces opposite to the parking target position with respect to the travel direction of the towed vehicle 3 at the time of turning, the initial curvature is less than 0 (a trajectory in which turning is started in a direction opposite to the turning direction to the parking target position). In S17, the initial curvature is specified based on the connection angle between the towing vehicle 2 and the towed vehicle 3 when located at the candidate turning position and various types of information stored in the vehicle information DB 21.

Thereafter, in S18, the CPU 31 calculates, based on the recommended values of the turning curvature X, the incremental steering curvature gradient α, and the steering return curvature gradient β that are acquired in S16 and the initial curvatures specified in S17, the backward trajectories of the towing vehicle 2 and the towed vehicle 3 when the backward movement is assumed to be started from the candidate turning position to be processed. Based on the parking target position acquired in S11 and the candidate turning position to be processed, the entry angle Δθ (also corresponding to the angle amount required to turn to enter the parking target position) from the candidate turning position to be processed to the parking target position is specified (see FIG. 6), and the backward trajectory calculated in S18 is set to a trajectory aligned with the entry angle Δθ. It does not matter whether the backward trajectory passes through the parking target position while being aligned with the entry angle Δθ. It is not necessary to calculate the backward trajectory for both the towing vehicle 2 and the towed vehicle 3, and it is acceptable to calculate only one of them. For example, only the backward trajectory of the towed vehicle 3 may be calculated.

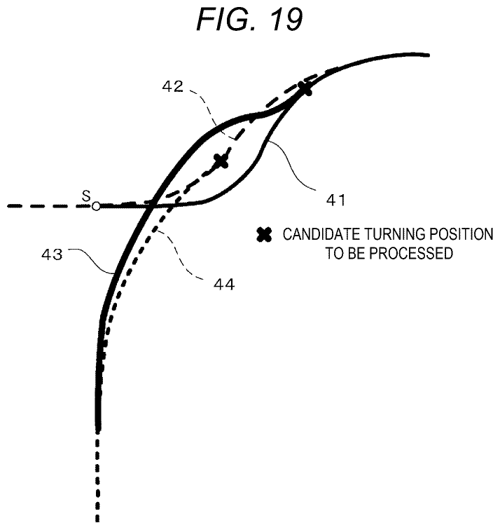

Here, FIG. 19 is a diagram illustrating an example of the backward trajectory calculated in S18. As illustrated in FIG. 19, a backward trajectory 43 of the towing vehicle 2 is a trajectory in which backward movement is performed from the candidate turning position to be processed that is set on the forward trajectory 41 of the towing vehicle 2. A backward trajectory 44 of the towed vehicle 3 is a trajectory in which backward movement is performed from the candidate turning position to be processed that is set on the forward trajectory 42 of the towed vehicle 3. In particular, the backward trajectory 43 of the towing vehicle 2 is a travel trajectory including the counter steering operation and the incremental steering operation, and the backward trajectory 44 of the towed vehicle 3 includes a section (first section) in which the traveling is performed while increasing the curvature from the initial curvature to the recommended turning curvature X at the recommended incremental steering curvature gradient α, a section in which the traveling is performed while maintaining the turning curvature X, and a section (second section) in which the traveling is performed while reducing the curvature from the turning curvature X at the recommended steering return curvature gradient β.

For the backward trajectories 43 and 44, the entry angle Δθ to the parking target position is aligned. That is, the backward trajectory is a trajectory in which turning is performed by an amount required to enter the parking target position, but the trajectory does not necessarily pass through the parking target position.

After the processing in S16 to S18 is executed for all the candidate turning positions set in S15 and the backward trajectory is calculated, the process proceeds to S19.

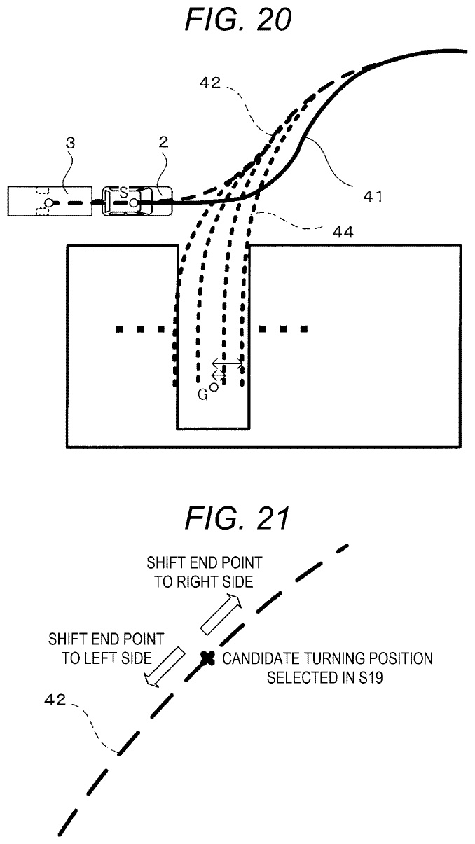

In S19, the CPU 31 compares the backward trajectories calculated in S18 for each of the candidate turning positions, and selects, from the plurality of candidate turning positions, the candidate turning position at which an end point of the backward trajectory is closest to the parking target position. The backward trajectories of the towing vehicle 2 may be compared, or the backward trajectories of the towed vehicle 3 may be compared. For example, FIG. 20 illustrates an example of comparing the backward trajectories 44 of the towed vehicle 3. In the example illustrated in FIG. 20, an end point of the second backward trajectory 44 from the right is closest to the parking target position G, and thus the candidate turning position corresponding to that backward trajectory 44 is selected.

Next, in S20, the CPU 31 corrects the candidate turning position selected in S19 in a direction in which the end point of the backward trajectory approaches the parking target position, and finally determines the corrected candidate turning position as the turning position. For example, in the case of comparing the backward trajectories 44 of the towed vehicle 3 as illustrated in FIG. 20, when the end point of the backward trajectory 44 of the candidate turning position selected in S19 is shifted to the right with respect to the parking target position G, the end point of the backward trajectory 44 can be brought closer to the parking target position G by moving the candidate turning position toward the parking start position along the forward trajectory 42 as illustrated in FIG. 21. On the other hand, when the end point of the backward trajectory 44 of the candidate turning position selected in S19 is shifted to the left with respect to the parking target position G, the end point of the backward trajectory 44 can be brought closer to the parking target position G by moving the candidate turning position away from (forward of) the parking start position along the forward trajectory 42 as illustrated in FIG. 21.

In the correction in S20, it is desirable to correct the candidate turning position such that the candidate turning position is a position a predetermined distance (for example, 30 cm) forward along the forward trajectory from a turning position at which the end point of the backward trajectory coincides with the parking target position (on a side away from the parking start position). As a result, even when an error occurs in the measurement or calculation during the process of S11 to S20, that is, even when the trajectory for moving backward from the turning position finally determined in S20 is a trajectory that actually makes it difficult to reach the parking target position, the correction can be performed during the backward movement without redoing the parking.

Subsequently, in S21, the CPU 31 outputs, as a recommended travel trajectory from the parking start position to the parking target position, a combination of the forward trajectory up to the turning position determined in S20 among the forward trajectories acquired in S13 and S14 and the backward trajectory for moving backward from the turning position determined in S20. Since the calculation of the backward trajectory for moving backward from the turning position determined in S20 is the same as that in S18, the description thereof will be omitted. In S21, the travel trajectory of only one of the towing vehicle 2 or the towed vehicle 3 may be output. The travel trajectory of the towing vehicle 2 may be output as the forward trajectory, and the travel trajectory of the towed vehicle 3 may be output as the backward trajectory, or vice versa.

The parking assistance device 1 can then execute parking assistance for the towing vehicle 2 by controlling each drive unit based on the travel trajectory output in S21. Specifically, the parking assistance device 1 transmits, to the vehicle control ECU 24 via the CAN, various types of assistance information on automatic driving assistance such as the travel trajectory generated in S21. The vehicle control ECU 24 executes the automatic driving assistance using the received various types of assistance information. Specifically, the steering, the drive source, the brake, and the transmission are controlled such that the towing vehicle 2 moves from the parking start position to the parking target position along the travel trajectory generated in S21. In the automatic driving assistance, only the steering operation may be automatically performed, and the accelerator, the brake, and the shift position operation may be manually performed. On the other hand, it is not essential for the towing vehicle 2 to be equipped with the above-described automatic driving assistance, and the towing vehicle 2 may be a vehicle that can only be driven manually. In this case, instead of the automatic driving assistance, the steering operation guidance, the brake, the accelerator, and the shift position operation guidance are performed to travel along the travel trajectory generated in S21.

During the transition to the parking assistance mode, it is desirable to display the travel trajectory and the current position of the vehicle in a comparable state on the liquid crystal display 15 such that the driver can confirm whether the parking operation is being performed in accordance with the generated travel trajectory. Further, an overhead image looking down from above may be generated based on images of surroundings captured by cameras installed on the towing vehicle 2 and the towed vehicle 3, and the overhead image may be displayed on the liquid crystal display 15 during the transition to the parking assistance mode.

As described in detail above, according to the parking assistance device 1 and the computer program executed by the parking assistance device 1 according to the present embodiment, in the case of calculating the travel trajectory for parking the towing vehicle connected with the towed vehicle, the parking start position and the parking target position are acquired (S11), the plurality of candidate turning positions are set on the forward trajectory of the towing vehicle 2 moving forward from the parking start position (S15), the backward trajectories of the towed vehicle 3 are calculated for the respective plurality of candidate turning positions when the backward movement is assumed to be started from the candidate turning positions set on the forward trajectory of the towing vehicle 2 (S18), the calculated backward trajectories of the towed vehicle 3 are compared for the respective plurality of candidate turning positions, and the turning position is set based on the comparison result (S19), and thus an appropriate turning position can be accurately set with less processing load as compared with the related art.

By comparing the calculated backward trajectories of the towed vehicle 3 for the respective plurality of candidate turning positions, the candidate turning position at which the end point of the backward trajectory of the towed vehicle 3 is closest to the parking target position is selected from the plurality of candidate turning positions (S19), the selected candidate turning position is corrected in the direction in which the end point of the backward trajectory of the towed vehicle 3 approaches the parking target position (S20), and the corrected candidate turning position is set as the turning position, and thus an optimal candidate turning position can be selected from a large number of candidate turning positions, and further the selected candidate turning position can be adjusted to a more appropriate position.

The position a predetermined distance forward along the forward trajectory of the towing vehicle 2 from the turning position at which the end point of the backward trajectory of the towed vehicle 3 coincides with the parking target position is set as the turning position, and thus even when an error occurs in the measurement or calculation, that is, the trajectory for moving backward from the finally determined turning position is a trajectory that actually makes it difficult to reach the parking target position, the correction can be performed during the backward movement without redoing the parking.

The backward trajectory of the towed vehicle 3 includes the first section in which the backward movement is performed while increasing the curvature from the initial curvature when the towing vehicle 2 makes a turn at the turning position set on the forward trajectory of the towing vehicle 2 to the predetermined turning curvature, and the second section in which the backward movement is performed while decreasing the curvature from the turning curvature, the transition of the connection angle between the towing vehicle 2 and the towed vehicle 3 when the towing vehicle 2 moves forward along the forward trajectory of the towing vehicle 2 is predicted, the initial curvature of the backward trajectory of the towed vehicle 3 when the backward movement is assumed to be started from the candidate turning position set on the forward trajectory of the towing vehicle 2 is determined based on the connection angle between the towing vehicle 2 and the towed vehicle 3 when the towing vehicle 2 is located at the candidate turning position, and the backward trajectory is calculated based on the determined initial curvature (S18), and thus the backward trajectory of the backward movement from the candidate turning position can be accurately calculated by considering the relationship between the connection angle and the curvature of the travel trajectory of the towed vehicle.

It is needless to say that this disclosure is not limited to the above-described embodiment, and various improvements and modifications can be made without departing from the scope of this disclosure.

For example, in the present embodiment, when setting the maximum curvature allowed for the travel trajectory of the towing vehicle 2 in the parameter specifying processing program (see FIG. 5) (S3), the first maximum curvature allowed for the travel trajectory in which the towing vehicle 2 turns in the direction same as that of the towed vehicle 3 (in the example illustrated in FIG. 6, the rightward direction along the backward direction) and the second maximum curvature allowed for the travel trajectory in which the towing vehicle 2 turns in the direction different from that of the towed vehicle 3 (in the example illustrated in FIG. 6, the leftward direction along the backward direction) are respectively set, and further, the second maximum curvature is set to a value smaller than that of the first maximum curvature, but the first maximum curvature may be the same as the second maximum curvature, or the first maximum curvature may be a value smaller than that of the second maximum curvature.

In the present embodiment, the maximum curvature allowed for the travel trajectory of the towing vehicle 2 is set, but an allowable maximum steering angle (steering angle) may be set instead of the curvature. The curvature of the travel trajectory of the towing vehicle 2 and the steering angle of the towing vehicle 2 traveling along the travel trajectory are basically linked, and thus it is possible to implement without any problem even when the maximum steering angle is set instead of the maximum curvature.

In the present embodiment, the values recommended for the turning curvature X, the incremental steering curvature gradient α, and the steering return curvature gradient β are specified in the parameter specifying processing program (see FIG. 5), but the values recommended for only some of the parameters may be specified instead of specifying the values recommended for all of the parameters.

In the present embodiment, in the parking assistance processing program (FIG. 14), the candidate turning position at which the end point of the backward trajectory is closest to the parking target position is selected from the plurality of candidate turning positions (S19), and further the selected candidate turning position is corrected (S20) and then determined as the turning position, but the correction in S20 does not necessarily have to be performed. That is, the candidate turning position selected in S19 may be determined as the turning position.

In the present embodiment, the processing in the parameter specifying processing program (FIG. 5) and the parking assistance processing program (FIG. 14) is executed by the parking assistance ECU 23 of the parking assistance device 1, but an execution entity can be changed as appropriate. For example, a control unit of the liquid crystal display 15, a vehicle control ECU, a control unit of a navigation device, and other in-vehicle devices may execute the processing.

### Summary of Present Embodiments

The present embodiment includes at least the following configurations.

A parking assistance device (1) for assisting in parking a towing vehicle (2) and a towed vehicle to be towed by the towing vehicle (3) when the towing vehicle and the towed vehicle are connected includes: a parking start position acquiring unit (31) configured to acquire a parking start position; a parking target position acquiring unit (31) configured to acquire a parking target position; and a travel trajectory generation unit (31) configured to generate a travel trajectory (41 to 44) from the parking start position to the parking target position. The travel trajectory includes a forward section in which forward movement is performed from the parking start position according to a set forward trajectory and a backward section in which backward movement is performed from a turning position set on the forward trajectory to the parking target position. The travel trajectory generation unit sets a plurality of candidate turning positions on the forward trajectory of the towing vehicle in the forward section, calculates, for the respective plurality of candidate turning positions, travel trajectories of the towed vehicle as backward trajectories when the backward movement is assumed to be started from the candidate turning positions set on the forward trajectory of the towing vehicle, and compares the calculated backward trajectories of the towed vehicle for the respective plurality of candidate turning positions, and sets the turning position based on a comparison result.

According to this configuration, in a case of calculating a travel trajectory for parking a towing vehicle connected with a towed vehicle, a plurality of candidate turning positions are set on a forward trajectory for moving forward from a parking start position, and a turning position is set by comparing backward trajectories when backward movement is assumed to be started from the respective candidate turning positions, and thus an appropriate turning position can be accurately set with less processing load as compared with the related art.

In the present embodiment, it is preferable that the travel trajectory generation unit (31) selects a candidate turning position at which an end point of the backward trajectory (44) of the towed vehicle is closest to the parking target position from the plurality of candidate turning positions by comparing the calculated backward trajectories of the towed vehicle (3) for the respective plurality of candidate turning positions, corrects the selected candidate turning position in a direction in which the end point of the backward trajectory of the towed vehicle approaches the parking target position, and sets the corrected candidate turning position as the turning position.

According to this configuration, an optimal candidate turning position can be selected from a large number of candidate turning positions and the selected candidate turning position can be adjusted to a more appropriate position.

In the present embodiment, it is preferable that the travel trajectory generation unit (31) sets, as the turning position, a position a predetermined distance forward along the forward trajectory (41) of the towing vehicle from a turning position at which an end point of the backward trajectory (44) of the towed vehicle (3) coincides with the parking target position.

According to this configuration, even when an error occurs in the measurement or calculation, that is, even when the trajectory for moving backward from the finally determined turning position is a trajectory that actually makes it difficult to reach the parking target position, the correction can be performed during the backward movement without redoing the parking.

In the present embodiment, it is preferable that the backward trajectory (44) of the towed vehicle (3) includes a first section in which the backward movement is performed while increasing a curvature from an initial curvature at a time when the towing vehicle makes a turn at the turn position set on the forward trajectory (41) of the towing vehicle (2) to a predetermined turning curvature, and a second section in which the backward movement is performed while decreasing the curvature from the turning curvature, and the travel trajectory generation unit (31) predicts a transition of a connection angle between the towing vehicle and the towed vehicle when the towing vehicle moves forward along the forward trajectory of the towing vehicle, and determines the initial curvature of the backward trajectory of the towed vehicle when the backward movement is assumed to be started from the candidate turning position set on the forward trajectory of the towing vehicle based on the connection angle between the towing vehicle and the towed vehicle at a time when the towing vehicle is located at the candidate turning position, and calculates the backward trajectory of the towed vehicle based on the determined initial curvature.

According to this configuration, by considering the relationship between the connection angle and the curvature of the travel trajectory of the towed vehicle, the backward trajectory for moving backward from the candidate turning position can be accurately calculated.

### REFERENCE SIGNS LIST

2 towing vehicle
3 towed vehicle
4 towing device
5 hitch ball
6 connection member
7 coupler
9 rear camera
15 liquid crystal display
31 CPU
32 RAM
33 ROM
41 forward trajectory of towing vehicle
42 forward trajectory of towed vehicle
43 backward trajectory of towing vehicle
44 backward trajectory of towed vehicle

1. A parking assistance device for assisting in parking a towing vehicle and a towed vehicle to be towed by the towing vehicle when the towing vehicle and the towed vehicle are connected, the parking assistance device comprising:
a parking start position acquiring unit configured to acquire a parking start position;
a parking target position acquiring unit configured to acquire a parking target position; and
a travel trajectory generation unit configured to generate a travel trajectory from the parking start position to the parking target position, wherein
the travel trajectory includes a forward section in which forward movement is performed from the parking start position according to a set forward trajectory and a backward section in which backward movement is performed from a turning position set on the forward trajectory to the parking target position, and
the travel trajectory generation unit
sets a plurality of candidate turning positions on the forward trajectory of the towing vehicle in the forward section,
calculates, for the respective plurality of candidate turning positions, travel trajectories of the towed vehicle as backward trajectories when the backward movement is assumed to be started from the candidate turning positions set on the forward trajectory of the towing vehicle, and
compares the calculated backward trajectories of the towed vehicle for the respective plurality of candidate turning positions, and sets the turning position based on a comparison result.

2. The parking assistance device according to claim 1, wherein
the travel trajectory generation unit
selects a candidate turning position at which an end point of the backward trajectory of the towed vehicle is closest to the parking target position from the plurality of candidate turning positions by comparing the calculated backward trajectories of the towed vehicle for the respective plurality of candidate turning positions,
corrects the selected candidate turning position in a direction in which the end point of the backward trajectory of the towed vehicle approaches the parking target position, and
sets the corrected candidate turning position as the turning position.

3. The parking assistance device according to claim 1, wherein
the travel trajectory generation unit sets, as the turning position, a position a predetermined distance forward along the forward trajectory of the towing vehicle from a turning position at which an end point of the backward trajectory of the towed vehicle coincides with the parking target position.

4. The parking assistance device according to claim 1, wherein
the backward trajectory of the towed vehicle includes a first section in which the backward movement is performed while increasing a curvature from an initial curvature at a time when the towing vehicle makes a turn at the turn position set on the forward trajectory of the towing vehicle to a predetermined turning curvature, and a second section in which the backward movement is performed while decreasing the curvature from the turning curvature, and
the travel trajectory generation unit
predicts a transition of a connection angle between the towing vehicle and the towed vehicle when the towing vehicle moves forward along the forward trajectory of the towing vehicle, and
determines the initial curvature of the backward trajectory of the towed vehicle when the backward movement is assumed to be started from the candidate turning position set on the forward trajectory of the towing vehicle based on the connection angle between the towing vehicle and the towed vehicle at a time when the towing vehicle is located at the candidate turning position, and calculates the backward trajectory of the towed vehicle based on the determined initial curvature.

5. The parking assistance device according to claim 2, wherein
the backward trajectory of the towed vehicle includes a first section in which the backward movement is performed while increasing a curvature from an initial curvature at a time when the towing vehicle makes a turn at the turn position set on the forward trajectory of the towing vehicle to a predetermined turning curvature, and a second section in which the backward movement is performed while decreasing the curvature from the turning curvature, and
the travel trajectory generation unit
predicts a transition of a connection angle between the towing vehicle and the towed vehicle when the towing vehicle moves forward along the forward trajectory of the towing vehicle, and
determines the initial curvature of the backward trajectory of the towed vehicle when the backward movement is assumed to be started from the candidate turning position set on the forward trajectory of the towing vehicle based on the connection angle between the towing vehicle and the towed vehicle at a time when the towing vehicle is located at the candidate turning position, and calculates the backward trajectory of the towed vehicle based on the determined initial curvature.

6. The parking assistance device according to claim 3, wherein
the backward trajectory of the towed vehicle includes a first section in which the backward movement is performed while increasing a curvature from an initial curvature at a time when the towing vehicle makes a turn at the turn position set on the forward trajectory of the towing vehicle to a predetermined turning curvature, and a second section in which the backward movement is performed while decreasing the curvature from the turning curvature, and
the travel trajectory generation unit
predicts a transition of a connection angle between the towing vehicle and the towed vehicle when the towing vehicle moves forward along the forward trajectory of the towing vehicle, and
determines the initial curvature of the backward trajectory of the towed vehicle when the backward movement is assumed to be started from the candidate turning position set on the forward trajectory of the towing vehicle based on the connection angle between the towing vehicle and the towed vehicle at a time when the towing vehicle is located at the candidate turning position, and calculates the backward trajectory of the towed vehicle based on the determined initial curvature.
